(19) United States
(12) Patent Application Publication
(10) Pub. No.: US 2005/0067948 A1
(43) Pub. Date: Mar. 31, 2005

(54) Electroluminescent device having an improved contrast

(76) Inventors: Coen Theodorus Hubertus Fransiscus Liedenbaum, Eindhoven (NL); Margaretha maria De Kok-Van Breemen, Eindhoven (NL)

Correspondence Address: Philips Electronics North America Corporation;Corporate Patent Counsel, PO Box 3001, Briarcliff Manor, NY, 10510, US

(21) Appl. No.: 10/498,136

(22) PCT Filed: Nov. 13, 2002
(86) PCT No.: PCT/IB02/04764

(30) Foreign Application Priority Data
Dec. 12, 2001 (EP) 01204853.4

(51) Int. Cl. H01J 1/62; H01J 63/04

(52) U.S. Cl. 313/504

(57) ABSTRACT

This invention relates to an electroluminescent display device (10) comprising D transmissive front substrate (11) and at least a first and a second light-emitting element (12, 15b), wherein said first element (12) is arranged to emit light at a first wavelength (λ1) and said second element (15b) is arranged to emit light at a second wavelength (λ2). Furthermore, a first absorbing layer (18), arranged to absorb light of said second wavelength (λ2) and transmit light of said first wavelength (λ1) is arranged between said first light-emitting element (12) and said front substrate (11).

This invention relates to an electroluminescent display device comprising a transmissive front substrate and at least a first and a second light-emitting element, wherein said first element is arranged to emit light at a first wavelength and said second element is arranged to emit light at a second wavelength.

An electroluminescent device as described above basically comprises a plurality of light-emitting elements or pixels, each comprising a thin layer of an electroluminescent material sandwiched between an anode structure and a cathode structure. Said pixels are arranged on a transmissive substrate to generate a display. The above electroluminescent material may be, for example, a polymer material constituting a PolyLED display.

Progress within the field of materials for use in polymeric emissive displays, such as the above PolyLED display, has recently resulted in the realisation of the first full colour device of this type. By means of inkjet printing, red, green and blue emissive materials may be deposited on a substrate in a controlled way, and furthermore it is possible to achieve a working fall colour display by properly driving the appropriate resulting pixels, each pixel comprising an amount of emissive material which is sandwiched between an anode and a cathode.

Alternatively, it is possible to realise a corresponding full colour display by using small molecule (OLED) organic electroluminescent materials which are deposited on a substrate or the like by means of vapour deposition. Functionally, these organic electroluminescent displays are similar to the above polymeric emissive displays.

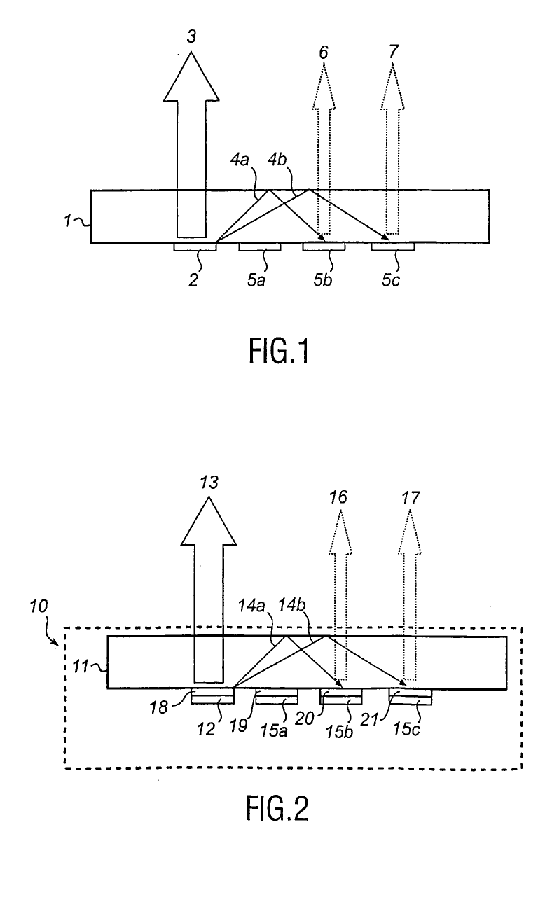

A basic colour display in accordance with the prior art is shown in FIG. 1. Such a display is constructed on a substrate 1, on which individually addressable pixels 2, 5a, 5b, 5c are arranged, for example, by means of inkjet printing or vapour deposition, as described above. For clarity, the addressing anodes and cathodes are not shown in FIG. 1, but may be of a passive or an active type, as is known to a person skilled in the art. In the example shown in FIG. 1, one pixel 2 is addressed, while the remaining pixels are inactive. Consequently, light will be generated by said pixel 2 and will thereafter proceed through the substrate 1 and partly leave the substrate as a light beam 3, available to hit the eye of a viewer. However, a part of the generated light will be reflected at the surfaces of the substrate, as is indicated in FIG. 1. This part of the reflected light will be wave-guided within the substrate, and as an example, two propagating beams, 4a and 4b, are shown in FIG. 1. Since light incident on the substrate-air interface, having an angle of incidence of more than a critical angle which is approximately 42 degrees for a glass substrate, is totally internally reflected, it will impinge on the neighbouring pixels 5b and 5c. Given the special geometrical constraints, it may be envisaged that there is a minimum distance between the pixel which is addressed and the surrounding pixels which may be undesirably illuminated by the internally reflected light. This distance is mainly governed by the thickness of the substrate, in combination with the above critical angle. In the example shown in FIG. 1, the pixel 5a lies within a dark zone, which may not be illuminated by reflected light from the above addressed pixel 2.

Under certain circumstances, such reflected light that hits the surrounding pixels may cause an optically excited fluorescent light emission from the pixel being hit. This is schematically shown in FIG. 1 as the light beams 6 and 7. This optically excited fluorescent light emission is due to light hitting the pixel, having a higher energy content than the light generated by the same pixel.

Consequently, a halo effect may occur when a pixel is being fired. This means that, due to the above-described emission effect, a fluorescent halo is generated around the pixel being fired. For example, for one display device tested by the applicant, when firing a blue pixel, a halo was generated in the surrounding yellow-green pixels. The radius and colour of the halo is, for example, dependent upon the substrate thickness, the distribution and the materials constituting the pixels.

Although the apparent brightness of the fluorescence halo is rather low, it should be noted that approximately 50% of the light generated, for example, in the above mentioned fired blue pixel, is normally captured within the substrate, and may consequently give rise to the above fluorescence halo effect. Furthermore, the illuminated area is by far larger than the source area, and in the above experiment only one source, i.e. the blue pixel was activated, whereas in a real application virtually all sources are on, with all the resulting halos overlapping and hence adding to the brightness of other activated or non-activated pixels. This effect is naturally undesired because it reduces the contrast of a displayed picture. Furthermore, the amount of fluorescence depends on the geometric overlap, as well as on the overlap of the emission of the source and the absorption of the material used in the illuminated pixel.

Consequently, a problem with the above displays is that the contrast, i.e. daylight as well as dark contrast, of the display may be severely degraded due to the above halo effect.

One method that has been proposed to overcome the above problem is based on the idea of extracting a substantial fraction or even all light from the substrate, and thereby reducing the light that is transmitted within the substrate. Such a method has been proposed by Horikx et al. in the patent document U.S. Pat. No. 5,955,837 (PHN 16014). However, extraction of all light is very hard to accomplish, for which a more robust method is required.

Consequently, it is an object of the invention to provide a device for preventing the generation of the above halo effect, thereby avoiding the above-described drawbacks of the prior art.

It is another object of the invention to provide a device in which internal optical crosstalk between pixels is avoided or reduced, by using a relatively simple manufacturing method.

The above and other objects are achieved by a device as described in the opening paragraph, which device is characterized in that a first absorbing layer, arranged to absorb light of said second wavelength and transmit light of said first wavelength, is arranged between said first light-emitting element and said front substrate. It should be noted that said first and second wavelengths are different from each other. Consequently, internally reflected light, due to firing of one light-emitting element, will not be able to reach the other light-emitting element, whereby the optically excited fluorescence or optical crosstalk is avoided. Preferably, said light-emitting elements comprise an organic electroluminescent material, such as an organic polymer material or a small molecule material.

In accordance with an embodiment of this invention, a corresponding second absorbing layer, arranged to absorb light of said first wavelength and transmit light of said second wavelength, is arranged between said second light-emitting element and said front substrate. Optically excited fluorescence may thereby be avoided.

In accordance with a preferred embodiment of the invention, at least one of said absorption layers is arranged to absorb light within a wavelength band, for which the corresponding light-emitting element has an absorption band. Only light that might give rise to optically excited fluorescence is thereby absorbed.

Furthermore, said absorption layers are arranged to transmit only the wavelength generated by the corresponding light-emitting element. Consequently, all other wavelengths are transmitted, resulting in elimination of fluorescence due to light coming from the outside of the display, such as daylight.

Preferably, at least one of said first and second absorbing layers comprises an optical colour filter. Optical colour filters are currently already used in other display technologies, and are therefore well-tested, reliable bulk components, offering a straight-forward realisation of said absorbing layers.

Alternatively, at least one of said first and second absorbing layers is constituted as a mixed layer comprising an absorbing material and a conductive polymer material. Such a conductive polymer layer, e.g. a PEDOT layer, is already present in most organic electroluminescent displays, and consequently this solution offers a realisation of the above absorbing layers, without adding an extra separate component to the display device. Furthermore, since the absorbing material is included in the conductive polymer layer, this layer may be manufactured in a single manufacturing step, thereby saving time during production. Suitably, said absorbing layer comprises an absorbing material which is an organic polymer and a small molecule material or a combination thereof Preferably, said absorbing layer is distributed on said substrate by means of inkjet printing, which is a straight-forward approach to applying such layers, for example, polymer light-emitting layers on a substrate. Alternatively, for small molecule organic light-emitting materials, said absorbing layer may be distributed on said substrate by means of evaporation.

In accordance with a preferred embodiment of the invention, the display device further comprises a third light-emitting element, arranged to emit light at a third wavelength, wherein said first absorption layer is arranged to absorb light of said first and second wavelengths, respectively. In this way, a multi-colour display may be obtained. As mentioned above, only wavelengths for which the corresponding light-emitting element has an absorption band need to be absorbed, so that it is not necessary to provide, for example, a green emissive pixel with an absorption layer absorbing red light, because the green emissive pixel lacks an absorption band for red light.

Currently preferred embodiments of the invention will hereinafter be described in closer detail, with reference to the accompanying drawings.

FIG. 1 is a schematic drawing of a cross-section of an organic electroluminescent display in accordance with the prior art, showing internal reflection in the organic electroluminescent display.

FIG. 2 is a schematic drawing of a cross-section of an organic electroluminescent display device in accordance with this invention.

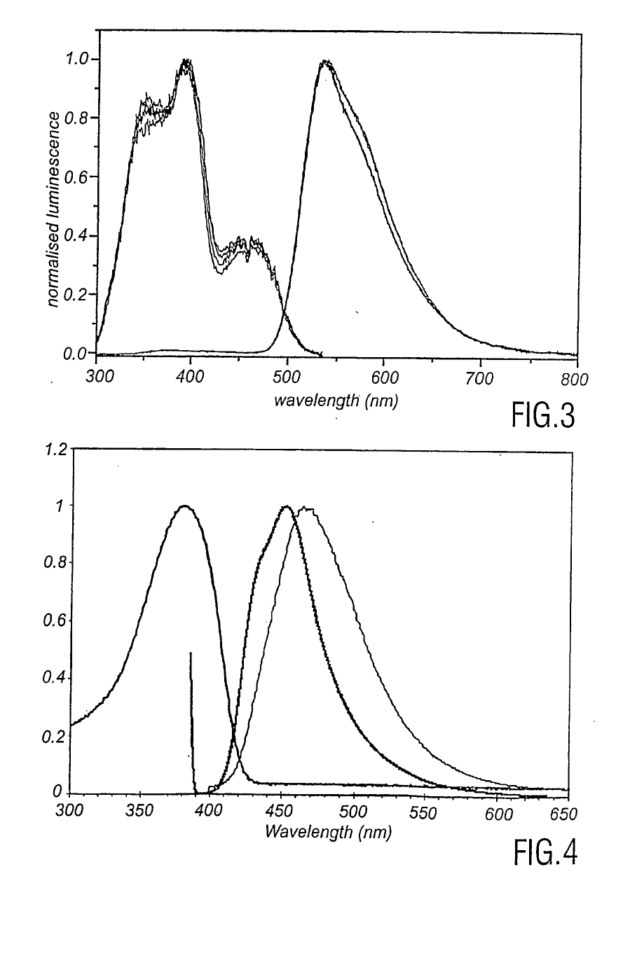

FIG. 3 as a graph showing the excitation and emission for a green colour material, shown by way of example.

FIG. 4 as a graph showing the excitation and emission for a blue colour material, shown by way of example.

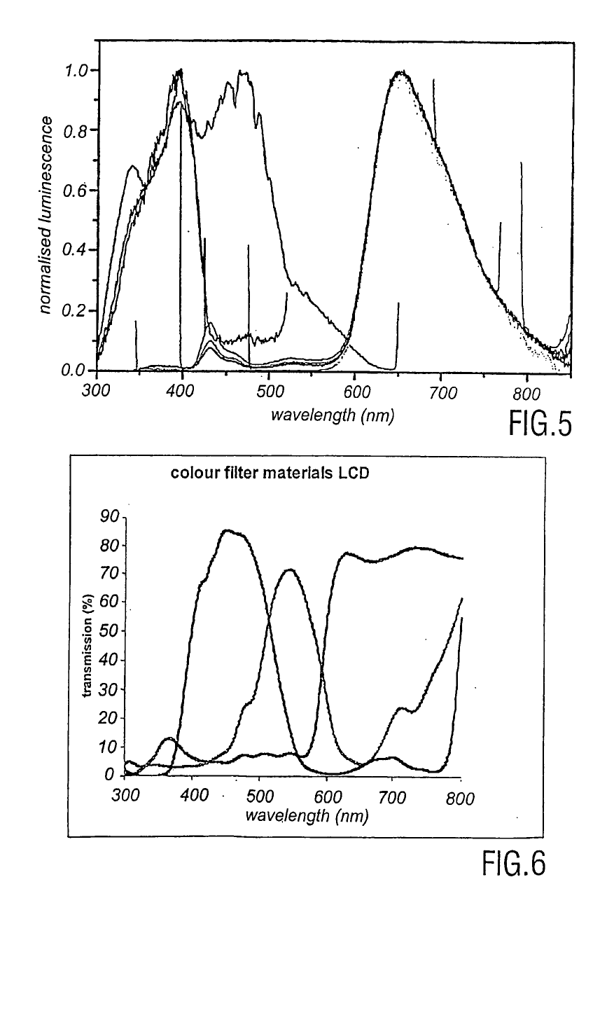

FIG. 5 as a graph showing the excitation and emission for a red colour material, shown by way of example.

FIG. 6 is a graph showing the transmission spectra of prior-art colour filter materials.

A display device 10 in accordance with the invention is shown in FIG. 2. The display device comprises a substrate 11 having an inner and an outer side. The outer side is arranged to face a viewer. A plurality of light-emitting pixels 12, 15a, 15b, 15c is arranged on the inner side. Each pixel essentially comprises a layer of a light-emitting material, such as a polymeric or a small molecule organic light-emitting material which is sandwiched between two electrodes (not shown in detail) in known manner. Furthermore, a respective absorbing layer 18, 19, 20, 21 is arranged between the inner surface and each light-emitting pixel 12, 15a, 15b, 15c. Each absorbing layer is arranged to transmit light within the wavelength interval generated by the corresponding light-emitting pixel, and absorb light outside this interval, and more specifically absorbing light in bands on the short wavelength side of the emissive wavelength, i.e. absorb light having a higher energy content than the light generated by the same pixel.

The function of a display device as described above will hereinafter be described by means of an example.

A control unit (not shown) sends a control signal to the light-emitting pixel 12, here a blue light-emitting pixel, for firing said pixel. The light-emitting pixel 12 thus emits blue light λ1, which is arranged to propagate through the absorbing layer 18, being a blue colour filter, in this case transmitting blue light, and into the substrate 11. In the substrate, a part of the light propagates normally and exits the substrate 11 as a light beam 13, being arranged to partly hit the eye of a potential viewer. However, as described above, a part of the emitted light will be wave-guided within the substrate, and this is schematically shown in FIG. 2 as the light beams 14a and 14b.

Furthermore, in this example, the pixel 15b is a yellow-green light-emitting pixel, and the corresponding absorbing layer 20 is arranged to transmit yellow-green light λ2 and absorb light outside that wavelength interval, for example, blue light λ1. The pixel 15c is a red light-emitting pixel, and the corresponding absorbing layer 21 is arranged to transmit red light and absorb light outside that wavelength interval, for example, blue light. It is sufficient to let the absorbing layer absorb light having a higher energy content than the light emitted by the corresponding pixel, because only such high energy light will cause optically excited fluorescence.

A part of the internally wave-guided light emitted by the blue light-emitting pixel 12, schematically shown as the beam 14a in FIG. 2, will hit the yellow green absorbing layer 20 in which the blue light will be absorbed. Consequently, the blue light, emitted by the neighbouring pixel will never hit the yellow-green light-emitting pixel 15b, and will therefore not generate any optically excited fluorescence in said pixel 15b. Correspondingly, a second part of the internally wave-guided light emitted by the blue light-emitting pixel 12, schematically shown as the beam 14a in FIG. 2, will hit the red absorbing layer 20 in which the blue light will be absorbed in a corresponding manner. Consequently, the blue light, emitted by the neighbouring pixel will never hit the red light-emitting pixel 15c, and will therefore not generate any optically excited fluorescence.

Consequently, the above inventive construction prevents the generation of optically excited fluorescence, and hence results in the desired characteristics for the display as a whole.

The absorbing layers 18, 19, 20, 21 may be manufactured by normal optical colour filters, which are also present in, for example, prior-art liquid crystal display devices. In this case, a slab or a layer of colour filter material is introduced between the substrate and the respective one of said light-emitting elements.

Another way of achieving the absorbing layers according to the present invention is to mix an absorbing material with a conductive polymer layer, such as a PEDOT layer, already present in prior-art PolyLED devices. The PEDOT layer of the display device serves two functions. First, it serves as a buffer layer to reduce the change when having an electrical short in the pixel, and secondly it provides a stable electrical work function for optimal injection of carriers in the electroluminescent layer. The introduction of inkjet printing or evaporation in combination with this special mixture will lead to the desired optical properties as well as the possibility to have locally different filters on the substrate. Furthermore, the last-mentioned method does not introduce any other technology or means of manufacture than those already necessary to manufacture prior-art devices. It is also possible to tune the absorbing materials, i.e. the colour co-ordinates of the materials, in order to enhance the colour purity and stability of the emission of the individual pixels. In order to greatly enhance the characteristics, narrow-band optical filters are desired.

As an example of the above described inventive construction, a full-colour display may be realised. In this case, three groups of pixels, arranged to emit three different colours, for example, red (R), green (G), and blue (B), are interspersed to form a display. Correspondingly, a colour filter for essentially transmitting the colour emitted by the pixel is arranged between each pixel and the substrate. However, in this case, each colour filter is arranged to absorb all wavelengths generated by the display, except the wavelength transmitted, as described above. Consequently, a blue colour filter, for example, will transmit blue light and absorb light within the red and green wavelength bands, and correspondingly for the green and red colour filters.

In the case that the colour filter material is provided as an additive being mixed with the PEDOT layer, as described above, the colour filter material shall fulfil the following requirements.

The additive must not change crucial PEDOT characteristics, like resistivity and processibility (viscosity) and be soluble in water.

Stability under the processing and driving circumstances of a light-emitting display. This implies an electrochemical stability as PEDOT transports holes in the light-emitting display structure and actually acts as a hole-injecting electrode for the organic electroluminescent material. It must also be stable in the PEDOT medium, i.e. an acidic, aqueous solution (during processing) as well as in the PEDOT polymer layer.

To fulfil its function as an optical filter, it must absorb the light with wavelengths that light up the other two coloured pixels, for the full-colour application described above, and should not fluoresce on the absorbed light.

To ensure sufficient efficiency of the pixels, one must enable light of all present colours, such as red, green and blue in the example above, to leave the display, in order to hit the eye of a potential viewer.

The requirements mentioned under 3) and 4) will hereinafter be described in closer detail.

As an example, three colour materials fulfilling the above requirements, here represented by a blue dye, a green dye and a red dye may be used. The following excitation and emission spectra for the respective one of said colour materials are shown in FIG. 3 (Green), FIG. 4 (Blue) and FIG. 5 (Red).

The colour filter materials used for prior-art LCDs, whose transmission spectra is shown in FIG. 6, are good starting materials in the search for suitable colour filter materials for organic electroluminescent displays, as their transmission allows the electroluminescent light of the red, green and blue material to leave the display, while the pixels are protected from internally reflected light from higher energy photons of the light, as these photons are absorbed by the filters. This can easily be concluded by comparing the absorption characteristics in FIGS. 4, 5 and 6 with the transmission characteristics in FIG. 6. Guided by FIGS. 3 to 6, a person skilled in the art may easily pick suitable colour materials for use in the present invention.

It should be noted that, although the invention has been described hereinbefore with reference to a currently preferred embodiment of the invention, different constructions are possible without departing from the scope and spirit of this invention, as defined by the appended claims. For example, it should be noted that the important aspect of this invention is to place the absorbing layer between the substrate and the light-emitting layer. The position of other layers in relation to the substrate and the light-emitting layers, such as electrode layers for driving the display, are not relevant for this invention.

It is also obvious to those skilled in the art that the references to wavelength are also intended to include defined wavelength intervals, or groups of defined wavelength intervals.

It should further be noted that the present invention may not only be used in displays using organic polymer or small molecule materials, as described above, but is in fact applicable to all displays which use fluorescent materials.

In summary, this invention relates to an electroluminescent display device (10) comprising a transmissive front substrate (11) and at least a first and a second light-emitting element (12, 15b), wherein said first element (12) is arranged to emit light at a first wavelength (λ1) and said second element (15b) is arranged to emit light at a second wavelength (λ2). Furthermore, a first absorbing layer (18), arranged to absorb light of said second wavelength (12) and transmit light of said first wavelength (λ1), is arranged between said first light-emitting element (12) and said front substrate (11).

1. An electroluminescent display device (10) comprising a transmissive front substrate (11) and at least a first and a second light-emitting element (12, 15b), wherein said first element (12) is arranged to emit light at a first wavelength (λ1) and said second element (15b) is arranged to emit light at a second wavelength (λ2), characterized in that a first absorbing layer (18), arranged to absorb light of said second wavelength (λ2) and transmit light of said first wavelength (λ1), is arranged between said first light-emitting element (12) and said front substrate (11).

2. A display device as in claim 1, wherein said light-emitting elements comprise an organic electroluminescent material, such as an organic polymer material or a small molecule material.

3. A display device as in claim 1, wherein a corresponding second absorbing layer (20), arranged to absorb light of said first wavelength (λ1) and transmit light of said second wavelength (λ2), is arranged between said second light-emitting element (15b) and said front substrate (11).

4. A display device as in claim 1, wherein at least one of said absorption layers (18, 20) is arranged to absorb light within a wavelength band, for which the corresponding light-emitting element (12, 15b) has an absorption band.

5. A display device as in claim 1, wherein said absorption layers (18, 20) are arranged to transmit only the wavelength generated by the corresponding light-emitting element (12, 15b).

6. A display device as in claim 1, wherein at least one of said first and second absorbing layers (18, 20) comprises an optical colour filter.

7. A display device as in claim 1, wherein at least one of said first and second absorbing layers (18, 20) is constituted as a mixed layer comprising an absorbing material and a conductive polymer material.

8. A display device as in claim 7, wherein said absorbing layer (18, 20) is distributed on said substrate by means of inkjet printing.

9. A display device as in claim 7, wherein said absorbing layer (18, 20) comprises an absorbing material which is an organic polymer and a small molecule material or a combination thereof.

10. A display device as in claim 1, further comprising a third light-emitting element (15c), arranged to emit light at a third wavelength (λ3), wherein said first absorption layer is arranged to absorb light of said first and second wavelengths (λ1,λ2), respectively.
